(19) United States
(12) Patent Application Publication
(10) Pub. No.: US 2015/0288018 A1
(43) Pub. Date: Oct. 8, 2015

(54) Secondary Battery Type Fuel Cell System And Manufacturing Process Therefor

(71) Applicant: Konica Minolta, Inc., Chiyoda-ku, Tokyo (JP)

(72) Inventor: Jun Yamada, Chiyoda-ku (JP)

(21) Appl. No.: 14/437,698

(22) PCT Filed: Oct. 11, 2013
(86) PCT No.: PCT/JP2013/077708

§ 371 Date: Apr. 22, 2015

(30) Foreign Application Priority Data
Oct. 23, 2012 (JP) 2012-233721

(51) Int. Cl. H01M 8/18

(52) U.S. Cl. CPC H01M 8/186; H01M 2008/1293

(57) ABSTRACT

This secondary battery type fuel cell system is provided with: fine particles of a fuel generator which can generate a fuel gas through oxidation and be regenerated through reduction; a gas-permeable insulating material which covers each of the fine particles; and a solid oxide fuel cell unit which includes a fuel electrode and which has a power generation function of generating power through a reaction between an oxygen-containing oxidizer gas and a fuel gas fed from the fuel generator and an electrolysis function of electrolyzing a product of the reduction, said product being fed from the fuel generator in regenerating the fuel generator. The fine particles covered with the gas-permeable insulating material are distributed in the fuel electrode.

### TECHNICAL FIELD

The present invention relates to a secondary battery type fuel cell system that includes a solid oxide type fuel cell portion and a fuel generator, and is able to perform not only a power generation operation but also a charge operation and to a production process for the same.

### BACKGROUND ART

A solid oxide type fuel cell has a cell structure, in which a solid oxide electrolyte membrane, which uses, for example, yttria stabilized zirconia (YSZ) or a lanthanum gallate-based material (e.g., LSGM represented by general formula LaSrMgGaO), is sandwiched between a fuel electrode (anode) and an oxidant electrode (cathode) from both sides. And, a fuel gas flow path for supplying a fuel gas (e.g., hydrogen) to the fuel electrode and an oxidant gas flow path for supplying an oxidant gas (e.g., oxygen or air) to the oxidant electrode are formed, the fuel gas and the oxidant gas are supplied respectively to the fuel electrode and the oxidant electrode via these flow paths, whereby power generation is performed.

The solid oxide type fuel cell is required to raise an operation temperature higher than a solid polymer type fuel cell, but has an advantage of higher power generation efficiency than the solid polymer type fuel cell.

### CITATION LIST

### Patent Literature

Patent Document 1: JP-A-H11-501448
Patent Document 2: International Publication WO/2011/030625

### SUMMARY OF INVENTION

### Technical Problem

The patent document 1 and patent document 2 each disclose a fuel cell system that uses a combination of a solid oxide type fuel cell portion and iron (hydrogen generating member). In the above fuel cell system, during a power generation operation period of the system, the iron (hydrogen generating member) generates hydrogen through an oxidation reaction with water vapor, the solid oxide type fuel cell portion performs the power generation through a reaction between an oxidant gas containing oxygen and a fuel gas supplied from the iron (hydrogen generating member), and during a charge operation period, iron oxide (oxidized hydrogen generating member) is renewed through a reduction reaction with the hydrogen, and the solid oxide type fuel cell portion performs electrolysis of water vapor supplied from the iron oxide (oxidized hydrogen generating member).

In the patent document 1, the iron (hydrogen generating member) is disposed in a storage room different from a storage room where the solid oxide type fuel cell portion is stored. Besides, in the patent document 2, the iron (hydrogen generating member) is disposed such that an emission surface of the iron (hydrogen generating member) for emitting a fuel gas and a supply surface of the fuel electrode of the solid oxide type fuel cell portion to which a fuel gas is supplied are disposed in parallel with each other.

In the above fuel cell system, the power generation operation and charge operation of the system are repeated, whereby an oxide catalyst contained in the fuel electrode of the solid oxide type fuel cell portion is reduced to agglomerate with surrounding particles and a surface area of the oxide catalyst becomes small, so that performance deterioration of the fuel electrode occurs. As a result of this, there is a problem that reactivity of the power generation reaction and electrolysis reaction deteriorates to incur output decrease during the power generation period of the system and reduction in charged power during the charge operation period.

In light of the above situation, it is an object of the present invention to provide a secondary battery type fuel cell system that is able to curb the performance deterioration.

### Solution to Problem

To achieve the above object, a secondary battery fuel cell system reflecting an aspect of the present invention has a structure that comprises: micro-particles of a fuel generator that generate a fuel gas through an oxidation reaction and are renewable through a reduction reaction; a gas-permeable insulating material that covers each of the micro-particles; and a solid oxide type fuel cell portion that includes a fuel electrode and has a power generation function to perform power generation through a reaction between an oxidant gas containing oxygen and the fuel gas supplied from the fuel generator and an electrolysis function to perform electrolysis of a product of the reduction reaction which is supplied from the fuel generator during a renewal period of the fuel generator; wherein the micro-particles of the fuel generator covered with the gas-permeable insulating material are disposed in the fuel electrode.

### Advantageous Effects of Invention

According to the secondary battery type fuel cell system reflecting an aspect of the present invention, the micro-particles of the fuel generator are disposed in the fuel electrode of the solid oxide type fuel cell portion, namely, disposed near a reaction field (three-phase interface) of the solid oxide type fuel cell portion. Because of this, it is possible to curb a phenomenon, in which an oxide catalyst contained in the fuel electrode material is reduced to agglomerate with surrounding particles, by reduction of the micro-particles in an oxidation state of the fuel generator. Accordingly, it is possible to curb performance deterioration of the fuel electrode and secondary battery type fuel cell system.

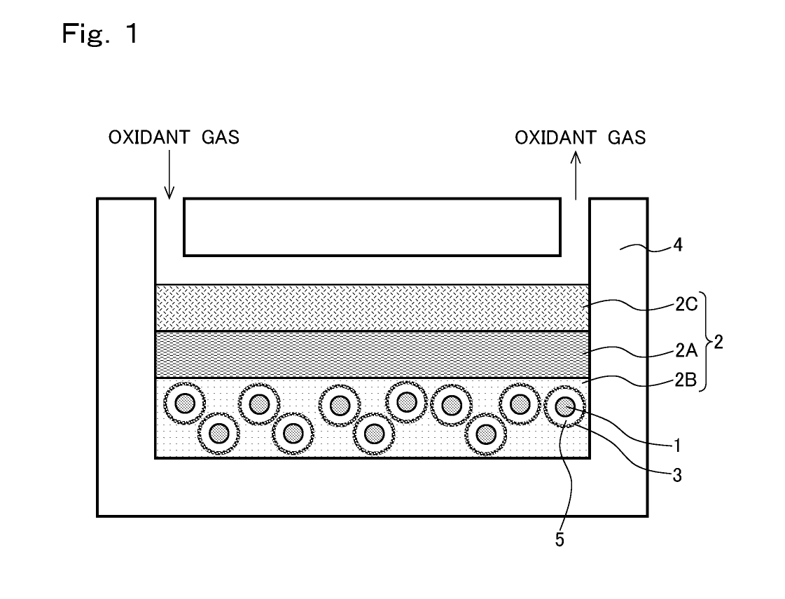

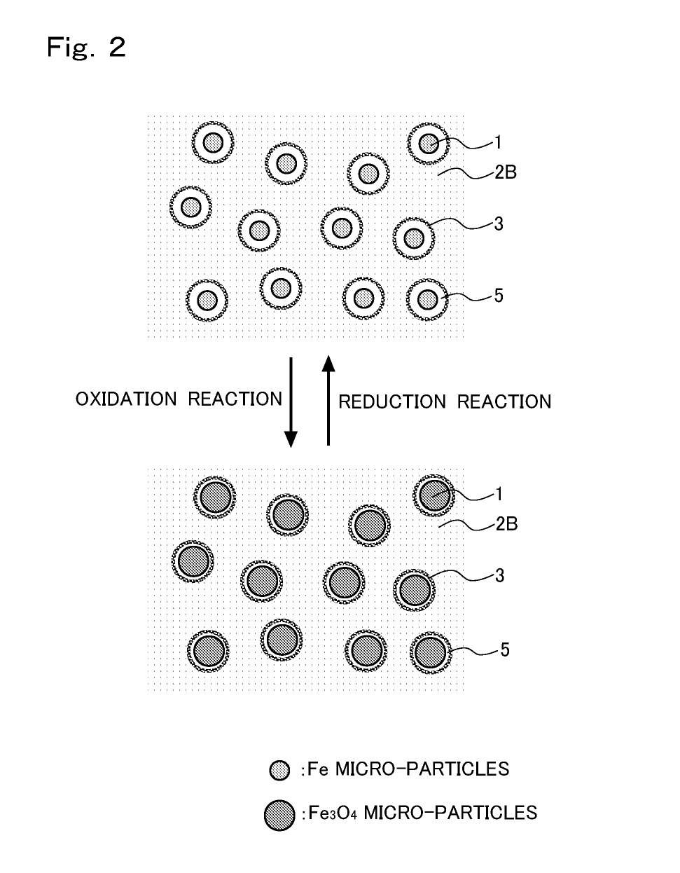

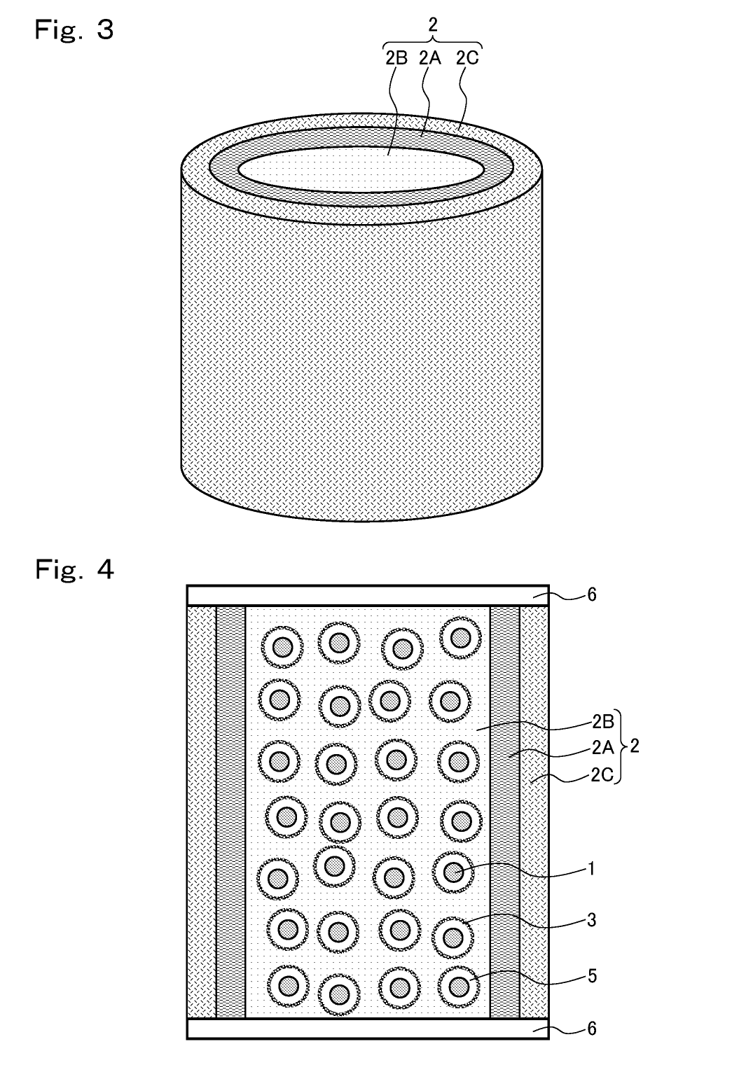

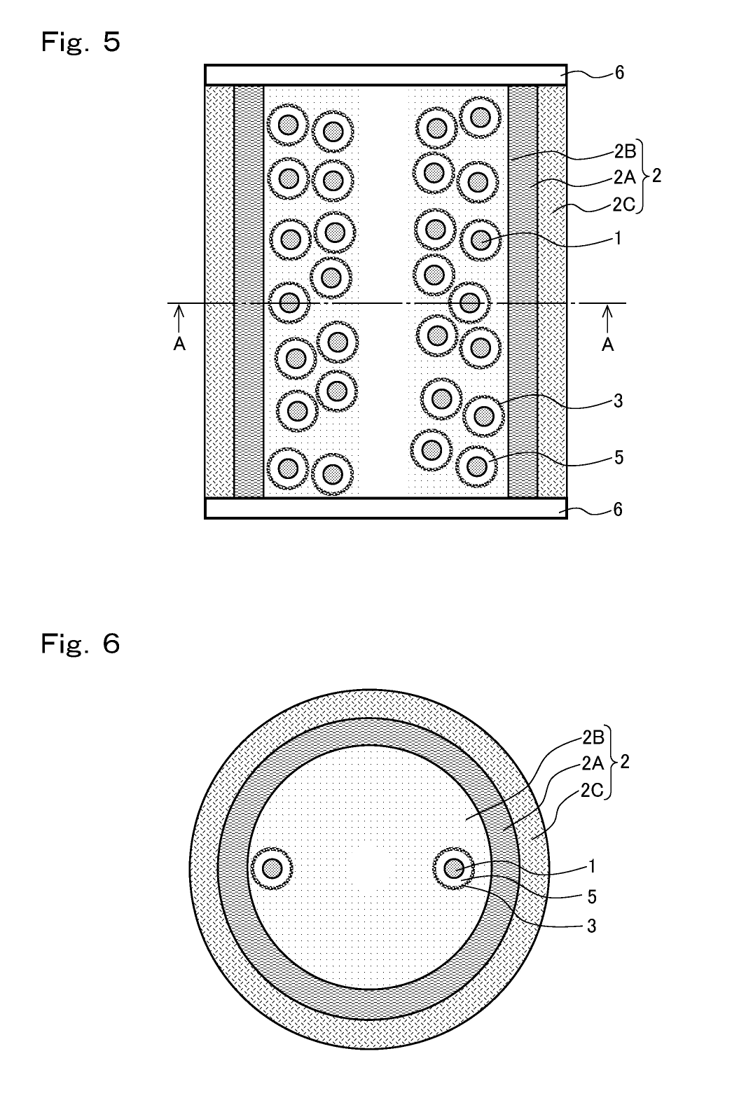

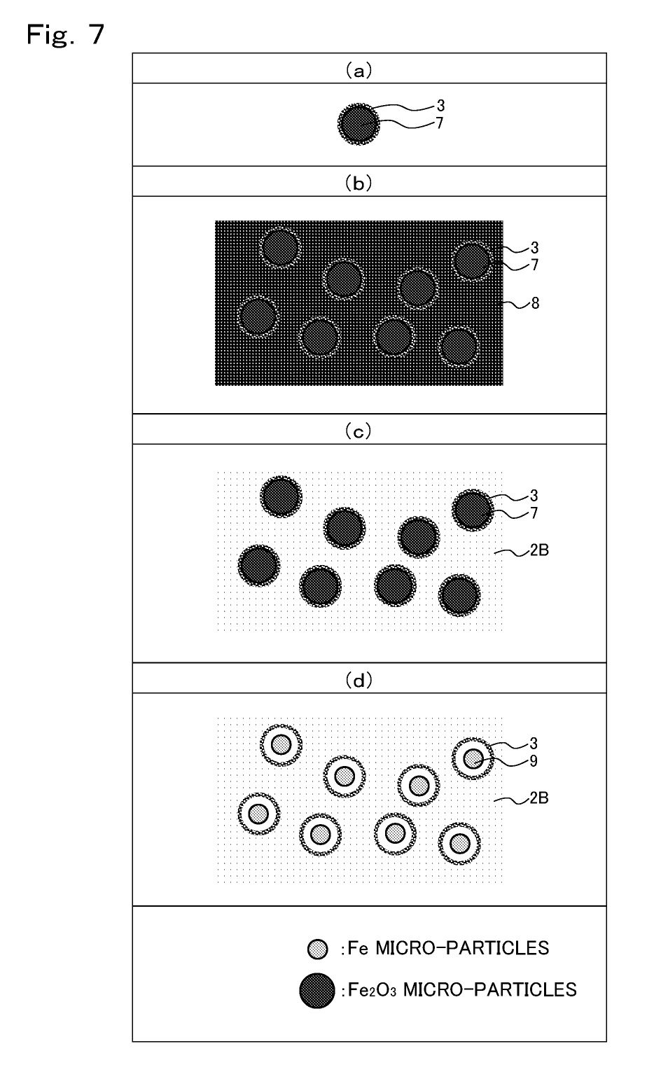

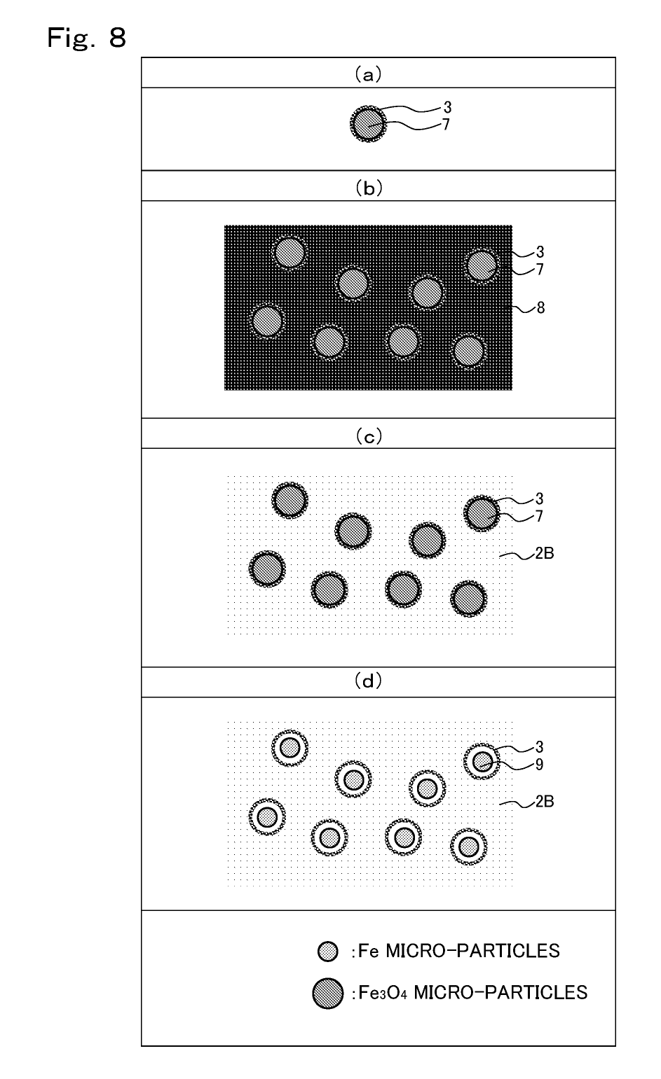

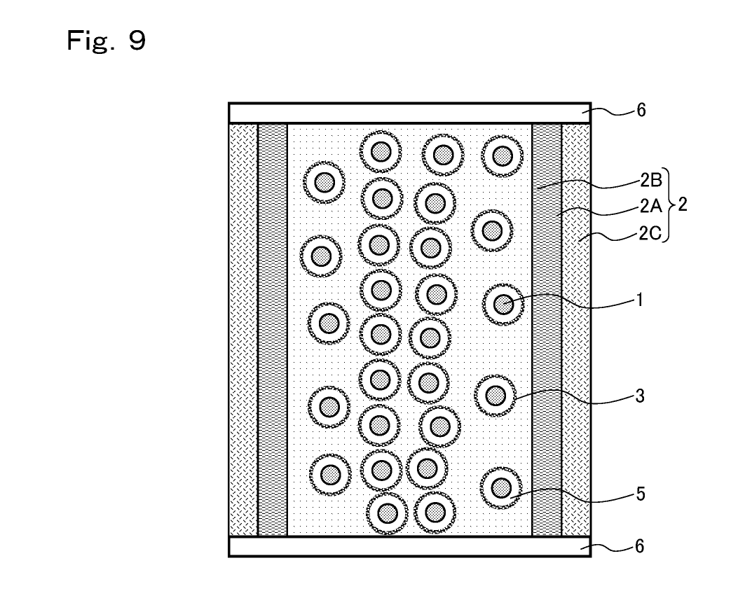

### BRIEF DESCRIPTION OF DRAWINGS

[FIG. 1] is a diagrammatic view showing a schematic structure of a secondary battery type fuel cell system according to a first embodiment of the present invention.

[FIG. 2] is a view showing behavior of a volume change caused by oxidation and reduction reactions of a fuel generator.

[FIG. 3] is a main-part perspective view of a secondary battery type fuel cell system according to a second embodiment of the present invention.

[FIG. 4] is a side sectional view of the secondary battery type fuel cell system according to the second embodiment of the present invention.

[FIG. 5] is a side sectional view of a modification example of the secondary battery type fuel cell system according to the second embodiment of the present invention.

[FIG. 6] is a transverse sectional view of the modification example of the secondary battery type fuel cell system according to the second embodiment of the present invention along an A-A line shown in FIG. 5.

[FIG. 7] is a view showing an example of a method for producing a fuel electrode that contains micro-particles of a fuel generator.

[FIG. 8] is a view showing another example of a method for producing a fuel electrode that contains micro-particles of a fuel generator.

[FIG. 9] is a side sectional view of another modification example of the secondary battery type fuel cell system according to the second embodiment of the present invention.

### DESCRIPTION OF EMBODIMENTS

Embodiments of the present invention are described hereinafter with reference to the drawings. In the meantime, the present invention is not limited to the embodiments described later.

### First Embodiment

FIG. 1 shows a schematic structure of a secondary battery type fuel cell system according to a first embodiment of the present invention. The secondary battery type fuel cell system according to the present embodiment includes: a fuel generator 1; a solid oxide type fuel cell portion 2; a gas-permeable insulating material 3; and a container 4 that houses the fuel generator 1, the solid oxide type fuel cell portion 2, and the gas-permeable insulating material 3. In the meantime, a heater and the like for adjusting a temperature may be disposed around the solid oxide type fuel cell portion 2 when necessary.

The fuel generator 1 has a form of micro-particles covered with the gas-permeable insulating material 3 and is disposed in a fuel electrode 2B of the solid oxide type fuel cell portion 2. As a method for putting the fuel generator 1 into the form of micro-particles, there is a method in which for example, a ball mill or the like is used to pulverize particles. Further, a surface area of the micro-particles may be further increased by generating cracks in the micro-particles by a mechanical method or the like, or the surface area of the micro-particles may be further increased by roughing the surface of the micro-particles by acid treatment, alkaline treatment, sandblasting or the like.

As a particle diameter of the micro-particles in a reduction state of the fuel generator 1, 50 μm or smaller is preferable from the viewpoint of reactivity, 5 μm or smaller is more preferable, and 0.5 μm or smaller is further preferable. In the meantime, a lower limit of the particle diameter in the reduction state is not limited especially, and it is also possible to use a particle diameter of 0.01 μm or smaller. Further, to obtain high reactivity with an oxidizing gas, it is especially preferable to use an average particle diameter of 0.05 to 0.5 μm of the micro-particles in the reduction state.

The gas-permeable insulating material 3 is formed to have many pores which transmit a gas and an average pore diameter of which becomes smaller than the average particle diameter of the micro-particles in the reduction state of the fuel generator 1. Besides, it is preferable that the maximum pore diameter of the gas-permeable insulating material 3 is formed to become smaller than the minimum particle diameter of the micro-particles in the reduction state of the fuel generator 1. In this way, it is possible to prevent the micro-particles in the reduction state of the fuel generator 1 from passing through the pores of the gas-permeable insulating material 3 to contact the material of the fuel electrode 2B. The fuel generator 1 is a metal of Fe or the like, and if the fuel generator 1 contacts the material of the fuel electrode 2B, the function of the fuel electrode 2B is influenced; accordingly, it is necessary to insulate them from each other. Besides, it is preferable that the average pore diameter of the gas-permeable insulating material 3 is 0.01 μm or larger to sufficiently secure gas permeability.

As the fuel generator 1, a member is usable, which uses, for example, a metal as a base material, to a surface of which a metal or a metal oxide is added; generates a fuel gas (e.g., hydrogen) through an oxidation reaction with an oxidizing gas (e.g., water vapor); and is renewable through a reduction reaction with a reducible gas (e.g., hydrogen). As the metal of the base material, there are, for example, Ni, Fe, Pd, V, Mg, and an alloy that uses these as a matrix, and among others, Fe is especially preferable because it is inexpensive and easy to machine. Besides, as the added metal, there are Al, Rh, Pd, Cr, Ni, Cu, Co, V, and Mo, and as the added metal oxide, there are SiO₂, TiO₂. However, the metal used for the base material and the added metal are not the same as each other.

As shown in FIG. 1, the solid oxide type fuel cell portion 2 has an MEA structure (Membrane Electrode Assembly) in which the fuel electrode 2B and the oxidant electrode 2C are connected to both surfaces of an solid oxide electrolyte membrane 2A. In the meantime, FIG. 1 shows the structure in which only one MEA is disposed; however, a plurality of MEAs may be disposed, or further the plurality of MEAs may be laminated. The solid oxide type fuel cell portion 2 has: a power generating function to perform power generation through a reaction between an oxidant gas (e.g., air) containing oxygen and the fuel gas (e.g., hydrogen) supplied from the fuel generator 1; and an electrolysis function to perform electrolysis of a product (e.g., water vapor) of the reduction reaction which is supplied from the fuel generator 1 during a renewal period of the fuel generator 1.

In the following description, the case where the fuel generator having Fe as a main boy is used as the fuel generator 1 and hydrogen is used as the fuel gas is described.

During a power generation period of the system, hydrogen is supplied from the fuel generator 1 to the fuel electrode 2B via the gas-permeable insulating material 3, and the oxidant gas is supplied to the oxidant electrode 2C, whereby a reaction of the following formula (1) occurs at the fuel electrode 2B.

H₂+O²⁻→H₂O+2e₃₁ (1)

On the other hand, a reaction of the following formula (2) occurs at the oxidant electrode 2C.

½O₂+2e⁻→O²⁻ (2)

Power supply to an external load (not shown) connected to the fuel electrode 2B and the oxidant electrode 2C is performed by a flow of the electrons in the reactions of these formulas (1) and (2). And, the oxygen ions reach the fuel electrode 2B via the solid oxide electrolyte membrane 2A. In the solid oxide type fuel cell portion 2, the above series of reactions are repeated, and as understood from the above formula (1), H₂ is consumed at the fuel electrode 2B to generate H₂O.

From the above formulas (1) and (2), a reaction at the solid oxide type fuel cell portion 2 during the power generation operation period is indicated by the following formula (3).

H₂+½O₂→H₂O (3)

The H₂O, which is generated by the reaction of the above formula (3) at a three-phase interface of a boundary between the fuel electrode 2B of the solid oxide type fuel cell portion 2 and the solid oxide electrolyte membrane 2A, diffuses, passes through the gas-permeable insulating material 3, and reaches the fuel generator 1 covered with the gas-permeable insulating material 3. And, because of an oxidation reaction indicated by the following formula (4), the fuel generator 1 consumes the H₂O supplied from the three-phase interface of the boundary between the fuel electrode 2B of the solid oxide type fuel cell portion 2 and the solid oxide electrolyte membrane 2A during the power generation period of the system, thereby generating and supplying H₂ to the fuel electrode 2B.

4H₂O+3Fe→4H₂+Fe₃O₄ (4)

When the oxidation reaction indicated by the above formula (4) occurs, Fe as the main body of the fuel generator 1 is oxidized to turn into Fe₃O₄, a volume of the micro-particles of the fuel generator 1 becomes 2.1 times, and an occupation rate of the micro-particle of the fuel generator 1 in a space 5 enclosed by the gas-permeable insulating material 3 becomes high (see FIG. 2). Even if Fe as the main body of the fuel generator 1 is oxidized to turn into Fe₃O₄ and the volume of the micro-particles of the fuel generator 1 increases, each micro-particle of the fuel generator 1 does not fly out of the space 5 enclosed by the gas-permeable insulating material 3 and does not contact the other micro-particles; accordingly, the micro-particles of the fuel generator 1 do not agglomerate with one another, the surface area does not become small, and the reactivity does not decline.

Besides, even in a case where the micro-particles of the fuel generator 1 go to an oxidation state, to prevent the micro-particles of the fuel generator 1 from pressing the gas-permeable insulating material 3 and the fuel electrode 2B, it is preferable that an internal volume of the gas-permeable insulating material 3 covering the micro-particles of the fuel generator 1 is formed to become larger than the volume of the micro-particles in the oxidation state of the fuel generator 1. In this way, it is possible to prevent mechanical deterioration of the fuel generator 1, the gas-permeable insulating member 3, and the fuel electrode 2B.

If the oxidation reaction of the iron indicated by the above formula (4) advances, a change from the iron to iron oxide advances, a remaining amount of the iron reduces, and the iron oxide increases. The gas-permeable insulating material 3 exists around each of the micro-particles of the fuel generator 1; accordingly, even if the micro-particles of the fuel generator 1 increase in the volume because of the oxidation reaction, the micro-particles do not come into contact nor agglomerate with one another. Because of this, the movement of the H₂O reacting with the micro-particles in the reduction state of the fuel member 1 is not hampered by the volume increase of the micro-particles of the fuel generator 1. In contrast to this, in a case where the fuel generator 1 is formed into pellet-like pieces and the micro-particles of the fuel generator 1 contact one another, a gap among the micro-particles of the fuel generator 1 becomes small because of the volume increase of the micro-particles of the fuel generator 1; accordingly, the movement of the H₂O reacting with the micro-particles in the reduction state of the fuel generator 1 is hampered by a volume change of the micro-particles of the fuel generator 1, so that there is a risk that the reactivity could decline.

During a charge period of the system, power supply from an external power source (not shown) connected to the fuel electrode 2B and the oxidant electrode 2C is performed. Because of this power supply, the solid oxide type fuel cell portion 2 operates as an electrolysis device; an electrolysis reaction, which is indicated by the following formula (5) and a reverse reaction of the above formula (3), occurs; H₂O is consumed at the three-phase interface of the boundary between the fuel electrode 2B of the solid oxide type fuel cell portion 2 and the solid oxide electrolyte membrane 2A to generate H₂; and the fuel generator 1 advances a change from the iron oxide to the iron to increase the remaining amount of the iron through a reduction reaction indicated by the following formula (6); in other words, the fuel generator 1 is renewed, consumes the H₂ supplied from the three-phase interface of the boundary between the fuel electrode 2B of the solid oxide type fuel cell portion 2 and the solid oxide electrolyte membrane 2A to generate H₂O, and supplies the H₂O to the fuel electrode 2B.

H₂O→H₂+½O₂ (5)

4H₂+Fe₃O₄→3Fe+4H₂O (6)

Like the power generation period of the system, also during the charge period of the system, the volume of the micro-particles of the fuel generator 1 changes (volume decrease during the charge period), but each micro-particle of the fuel generator 1 does not fly out of each space enclosed by the gas-permeable insulating material 3 and does not contact the other micro-particles; accordingly, the micro-particles of the fuel generator 1 do not agglomerate with one another, the surface area does not become small, and the reactivity does not decline.

Besides, the micro-particles of the fuel generator 1 are disposed in the fuel electrode 2B of the solid oxide type fuel cell portion 2, namely, disposed near the reaction field (three-phase interface) of the solid oxide type fuel cell portion 2. Because of this, during the charge period, it is possible to curb a phenomenon, in which an oxide catalysts such as NiO and the like contained in the fuel electrode material are reduced by the reducible gas to agglomerate with the surrounding particles, by earlier reduction of the micro-particles in the oxidation state of the fuel generator 1 which are reducible more easily than the oxide catalysts such as NiO and the like contained in the fuel electrode material. Accordingly, it is possible to curb performance deterioration of the fuel electrode 2B and secondary battery type fuel cell system.

### Second Embodiment

A secondary battery type fuel cell system according to a second embodiment of the present invention is described with reference to FIG. 3 and FIG. 4. In the meantime, in FIG. 3 and FIG. 4, the same parts as FIG. 1 are indicated by the same reference numbers and description of them is skipped.

FIG. 3 is a main-part perspective view of the secondary battery type fuel cell system according to the present embodiment, with illustration of a cover body 6 skipped. FIG. 4 is a side sectional view of the secondary battery type fuel cell system according to the present embodiment.

In the secondary battery type fuel cell system according to the present embodiment, the fuel electrode 2B has a column shape, the solid oxide electrolyte membrane 2A and the oxidant electrode 2C each have a cylindrical shape, and respective center axes of the fuel electrode 2B, solid oxide electrolyte membrane 2A, and oxidant electrode 2C are coaxial with one another. And, the cover body 6 for blocking gas transmission is disposed at both ends in a longitudinal direction (center axis direction) of the secondary battery type fuel cell system according to the present embodiment, and the fuel electrode 2B is disposed in a sealed space formed by the solid oxide electrolyte membrane 2A and the cover body 6.

Also in the secondary battery type fuel cell system according to the second embodiment of the present invention, like the secondary battery type fuel cell system according to the first embodiment of the present invention, the micro-particles of the fuel generator 1 covered with the gas-permeable insulating material 3 are disposed in the fuel electrode 2B of the solid oxide type fuel cell portion 2; accordingly, the same effects as the secondary battery type fuel cell system according to the first embodiment of the present invention are obtained.

In the meantime, as shown in FIG. 5 and FIG. 6, like the solid oxide electrolyte membrane 2A and the oxidant electrode 2C, the fuel electrode 2B may be formed to have a cylindrical shape. For example, in a case where the fuel electrode 2B is long in a longitudinal direction and the gas has difficulty in reaching a center in the longitudinal direction, by forming the fuel electrode 2B into a cylindrical shape, and providing a center portion of the cover 6 corresponding to a hollow portion of the fuel electrode 2B with a gas introduction aperture that is openable and closable, when reducing the fuel generator 1 in the oxidation state during a production period or after maintenance of the secondary battery type fuel cell system according to the second embodiment of the present invention, it becomes possible to introduce the reducible gas from the gas introduction aperture and make the reducible gas reach the center in the longitudinal direction of the fuel electrode 2B. Besides, the micro-particles of the fuel generator 1 may be compression-molded into pellet-like pieces with a gap left to allow the gas pass through, and many of the pieces may be crammed into the hollow portion of the fuel electrode 2B, or the micro-particles of the fuel generator 1 may be compression-molded into a cylindrical shape with a gap left to allow the gas pass through and may be disposed into the hollow portion of the fuel electrode 2B.

### Modifications

In the meantime, in the above second embodiment, the solid oxide electrolyte membrane 2A and the oxidant electrode 2C are formed outside the fuel electrode 2B. However, the solid oxide electrolyte membrane 2A and the fuel electrode 2B may be formed outside the oxidant electrode 2C. In the case where the solid oxide electrolyte membrane 2A and the fuel electrode 2B are formed outside the oxidant electrode 2C, a container, which encloses a whole surface in a circumferential direction and both ends in the longitudinal direction of the fuel electrode 2B, may be disposed, the fuel electrode 2B may be disposed in a sealed space formed by the container and the solid oxide electrolyte membrane 2A, and a flow path for supplying the oxidant gas to the oxidant electrode 2C may be disposed.

Besides, in the above embodiments, hydrogen is used as the fuel for the solid oxide type fuel cell portion 2; however, a reducible gas other than hydrogen such as carbon monoxide, hydrocarbon or the like may be used as the fuel for the fuel cell portion 2.

### Production Method of Fuel Electrode Containing Micro-Particles of Fuel Generator

An example of a production method of the fuel electrode 2B, in which the micro-particles of the fuel generator 1 are disposed in the space 5, is described with reference to FIG. 7.

To begin with, a surface of an iron oxide micro-particle 7 is coated with the gas-permeable insulating material 3 (see FIG. 7(a)). As coating methods of the gas-permeable insulating material 3, for example, there are: a method in which insulating nano-particles are attached to the surface of the iron oxide micro-particle 7; and a method in which a not-fine insulating layer is directly precipitated onto the surface of the iron oxide micro-particle 7 in a solution. In the meantime, unlike the structure shown in FIG. 7(a), a structure may be employed, in which surface treatment is applied to the surface of the iron oxide micro-particle 7 to from an organic material layer, then, the surface of the iron oxide micro-particle 7 is coated with the gas-permeable insulating material 3, thereafter, the organic material layer is removed, whereby a gap is disposed between the iron oxide micro-particle 7 and the gas-permeable insulating member 3. Besides, this heat treatment may be skipped, and the organic material layer may be removed in a burning step described later. As materials of the gas-permeable insulating material 3, there are, for example, aluminum oxide, silica, silica-alumina, mullite, cordierite, zirconia, stabilized zirconia, yttria stabilized zirconia, partially stabilized zirconia, alumina, magnesia, lanthanum calcium, lanthanum chromite, lanthanum strontium, porous glass and the like.

Next, a mixture is obtained by mixing: the iron oxide micro-particles 7 covered with the gas-permeable insulating member 3, the particles as the material of the fuel electrode 2B; and a sacrificial material for forming the pore of the fuel electrode 2B. As the micro-particles as the material of the fuel electrode 2B, there are, for example: a combination of yttria stabilized zirconia (YSZ) micro-particles and NiO micro-particles as the oxide catalyst; a combination of ceria-based micro-particles in which Gd, Sm or the like is substituted for a portion of ceria (CeO₂) and NiO micro-particles as the oxide catalyst; a combination of lanthanum gallate-based micro-particles in which Sr, Mg or the like is substituted for a portion of lanthanum gallate (LaGaO₃) and NiO micro-particles as the oxide catalyst and the like. Besides, as the above oxide catalyst, instead of the NiO micro-particles, it is possible to use: an oxide of Ni alloy such as Ni—Pd alloy, Ni—Ag alloy, Ni—Mn alloy, Ni—Co alloy, Ni—Fe alloy, Ni—Cu alloy, Ni—Zn alloy or the like; an oxide of Co alloy such as Co—Cu alloy, Co—Ti alloy or the like; or a ceramic-based material such as CeMnFeO or the like.

Next, to be suitable for a method and an apparatus used for the forming of the fuel electrode 2B, a solvent and the like are added to the mixture, and viscosity adjustment is performed. For example, in a case where the fuel electrode 2B having a sheet shape is formed, ethanol or toluene is added as the solvent to adjust the mixture such that printing becomes possible by blade coating or the like, and the mixture can be formed into a sheet shape by printing. Besides, in a case where the fuel electrode 2B having a cylindrical shape or a column-like shape is formed by using an extruder, the mixture is formed into a clay-like material.

It is possible to form the mixture after the adjustment into a sheet shape, a cylindrical shape, a column-like shape or the like by using a printing method, an extruder or the like. As shown in FIG. 7(b), the formed mixture contains: the iron oxide micro-particles 7; the gas-permeable insulating material 3; and the particles as the material of the fuel electrode 2B, the sacrificial material, the solvent and the like 8.

Next, the mixture formed in the sheet shape, cylindrical shape, column-like shape or the like is dried, further, thereafter, burned. In this way, the solvent component and the sacrificial material component vaporize, and as shown in FIG. 7(c), the fuel electrode 2B containing the iron oxide micro-particles 7 is obtained.

Lastly, reduction treatment is applied to the fuel electrode 2B containing the iron oxide micro-particles 7. A method of the reduction treatment is not especially limited. As an example of the reduction treatment, there is a method, in which the fuel electrode 2B containing the iron oxide micro-particles 7 is put into a hydrogen atmosphere and heated. The iron oxide micro-particles 7 are reduced by this reduction treatment to become iron micro-particles 9, and as shown in FIG. 7(d), it is possible to obtain the fuel electrode 2B in which the iron particle 9 (example of the micro-particle of the fuel generator 1) is disposed in the space 5 enclosed by the internal gas-permeable insulating material 3. In the meantime, this reduction treatment may be performed by the manufacturer of the fuel generator 1, or the burning step may be performed by the manufacturer, and the reduction treatment may be performed by recipients of the fuel generator 1 (e.g., a person who combines the fuel generator and the fuel cell portion to produce the fuel cell system, a user of the fuel cell system or the like).

In the meantime, in FIG. 7, Fe₂O₃ micro-particles are used as the iron oxide micro-particles. However, as shown in FIG. 8, the above method may be performed by using Fe₃O₄ micro-particles as the iron oxide micro-particles, and as shown in FIG. 8(d), the fuel electrode 2B may be obtained, in which the iron micro-particle 9 (example of the micro-particle of the fuel generator 1) is disposed in the space 5 enclosed by the internal gas-permeable insulating material 3. In the case where the Fe₂O₃ micro-particles are used, the internal volume of the gas-permeable insulating material 3 becomes larger than the volume of the micro-particles in the oxidation state of the fuel generator 1, and in the case where the Fe₃O₄ micro-particles are used, the internal volume of the gas-permeable insulating material 3 becomes substantially equal to the volume of the micro-particles in the oxidation state of the fuel generator 1.

### First Production Example of Secondary Battery Type Fuel Cell System According to the Present Invention

Here, a production example of the secondary battery type fuel cell system having the structure shown in FIG. 5 and FIG. 6 is described. As the micro-particles used as the material of the fuel electrode 2B, yttria stabilized zirconia (YSZ) micro-particles and NiO micro-particles are used. A clay-like mixture is obtained by mixing: the YSZ micro-particles having a particle diameter of several hundreds of nanometers; the NiO micro-particles having a particle diameter of several hundreds of nanometers; the Fe₂O₃ micro-particles whose surfaces are covered with the gas-permeable insulating material 3 made of aluminum oxide and have a particle diameter of about 0.5 μm; a polyvinyl butyral-based compound as a binder; an acrylic powder or carbon powder as a pore forming material; and water. The mixture is formed into a cylindrical shape having an outer diameter of 3 mm and an inner diameter of 2.4 mm by using an extruder.

Next, the formed mixture is dried at 50° C. for 10 hours, thereafter, a solid oxide electrolyte membrane layer is formed onto the cylindrical-shaped mixture. Slurry for a solid oxide electrolyte membrane is obtained by adding: powdered yttria stabilized zirconia (YSZ); a polyvinyl butyral-based compound as a binder; and a suitable amount of ethanol and toluene as solvents. The cylindrical-shaped mixture is coated with the slurry for a solid oxide electrolyte membrane by dip coating to form a solid oxide electrolyte membrane layer, and burning is performed, whereby a cylindrical body is obtained, in which the cylindrical-shaped solid oxide electrolyte membrane 2A is formed outside the cylindrical-shaped fuel electrode 2B that contains the iron oxide micro-particles.

Next, slurry for an oxidant electrode is obtained by adding a polyvinyl butyral-based compound as a binder, and a suitable amount of ethanol and toluene as solvents to powdered lanthanum manganite. The cylindrical-shaped body is coated with the slurry for an oxidant electrode by dip coating to form an oxidant electrode layer, thereafter, burning is performed in a hydrogen atmosphere. The iron oxide micro-particles contained in the fuel electrode 2B are reduced by the burning in the hydrogen atmosphere. Lastly, by gluing the cover body 6 to both ends in a longitudinal direction of the cylindrical body, the secondary battery type fuel cell system having the structure shown in FIG. 5 and FIG. 6 is obtained. In the meantime, the iron oxide micro-particles contained in the fuel electrode 2B may be reduced by: burning the oxidant electrode layer in an air atmosphere; gluing the cover body 6 to both ends in the longitudinal direction of the cylindrical body; then, supplying a reducible gas to the fuel electrode 2B disposed in the sealed space formed by the solid oxide electrolyte membrane 2A and the cover body 6 by using a gas introduction aperture or the like formable through the cover body 6.

### Second Production Example of Secondary Battery Type Fuel Cell System According to the Present Invention

Here, a production example of the secondary battery type fuel cell system having a structure shown in FIG. 9 is described. The secondary battery type fuel cell system having the structure shown in FIG. 9 has the same structure as the fuel cell system having the structure shown in FIG. 5 and FIG. 6 except for that the fuel electrode 2B has a column-like shape; the micro-particles of the fuel generator 1 are ununiformly distributed in the fuel electrode 2B: the micro-particles of the fuel generator 1 are sparse in a portion near the solid oxide electrolyte membrane 2A of the fuel electrode 2B, and the micro-particles of the fuel generator 1 are dense in a portion far from the solid oxide electrolyte membrane 2A of the fuel electrode 2B.

When the micro-particles of the fuel generator 1 go to the oxidation stare, the volume increases; accordingly, the gas flow is hampered. Accordingly, if many of the micro-particles of the fuel generator 1 are disposed in the portion near the solid oxide electrolyte membrane 2A of the fuel electrode 2B, because of oxidation of the micro-particles of the fuel generator 1 disposed in the portion near the solid oxide electrolyte membrane 2A of the fuel electrode 2B, there is a risk that the gas could not reach the micro-particles of fuel generator 1 disposed in the portion far from the solid oxide electrolyte membrane 2A of the fuel electrode 2B. As in the structure shown in FIG. 9, by disposing the micro-particles of the fuel generator 1 sparsely in the portion near the solid oxide electrolyte membrane 2A of the fuel electrode 2B and disposing the micro-particles of the fuel generator 1 densely in the portion far from the solid oxide electrolyte membrane 2A of the fuel electrode 2B, the gas becomes easy to be supplied to the micro-particles of the fuel generator 1 disposed in the portion far from the solid oxide electrolyte membrane 2A of the fuel electrode 2B; accordingly, it becomes easy to evenly use the micro-particles of the fuel generator 1 disposed in the fuel electrode 2B.

As the micro-particles used as the material of the fuel electrode 2B, yttria stabilized zirconia (YSZ) micro-particles and NiO micro-particles are used. A clay-like mixture is obtained by mixing: the YSZ micro-particles having a particle diameter of several hundreds of nanometers; the NiO micro-particles having a particle diameter of several hundreds of nanometers; the Fe₂O₃ micro-particles whose surfaces are covered with the gas-permeable insulating material 3 made of aluminum oxide and have a particle diameter of about 0.5 μm; a polyvinyl butyral-based compound as a binder; an acrylic powder or carbon powder as a pore forming material; and water. The mixture is formed into a column-like shape having an outer diameter of 3 mm by using an extruder.

Next, the formed mixture is dried at 50° C. for 10 hours, thereafter, a fuel electrode layer having a low mixture ratio of Fe₂O₃ micro-particles, and the solid oxide electrolyte membrane 2A are formed onto the column-like shape mixture. Slurry for a fuel electrode having a low mixture ratio of Fe₂O₃ micro-particles compared with the above mixture is obtained by adding: YSZ micro-particles having a particle diameter of several hundreds of nanometers; NiO micro-particles having a particle diameter of several hundreds of nanometers; Fe₂O₃ micro-particles whose surfaces are covered with the gas-permeable insulating material 3 made of aluminum oxide and have a particle diameter of about 0.5 μm; a polyvinyl butyral-based compound as a binder; and a suitable amount of ethanol and toluene as solvents. The column-like shape mixture is coated with the slurry for a fuel electrode by dip coating to form a fuel electrode layer which has a low mixture ratio of Fe₂O₃ micro-particles. The next method is the same as the first production example and description of it is skipped.

### Recapitulation

The secondary battery type fuel cell system described above has a structure (first structure) which includes: micro-particles of a fuel generator that generate a fuel gas through an oxidation reaction and are renewable through a reduction reaction; a gas-permeable insulating material that covers each of the micro-particles; and a solid oxide type fuel cell portion that includes a fuel electrode and has a power generation function to perform power generation through a reaction between an oxidant gas containing oxygen and the fuel gas supplied from the fuel generator and an electrolysis function to perform electrolysis of a product of the reduction reaction which is supplied from the fuel generator during a renewal period of the fuel generator; wherein the micro-particles of the fuel generator covered with the gas-permeable insulating material are disposed in the fuel electrode.

Besides, in the secondary battery type fuel cell system having the above first structure, a structure (second structure) may be employed, in which the micro-particles of the fuel generator are ununiformly distributed in the fuel electrode of the solid oxide type fuel cell portion: the micro-particles of the fuel generator are sparse in a portion near an electrolyte of the solid oxide type fuel cell portion, and the micro-particles of the fuel generator are dense in a portion far from the electrolyte of the solid oxide type fuel cell portion.

Besides, the production method of the secondary battery type fuel cell system described above has a structure (third structure) and is a method for producing the secondary battery type fuel cell system that includes: micro-particles of a fuel generator that generate a fuel gas through an oxidation reaction and are renewable through a reduction reaction; and a solid oxide type fuel cell portion that includes a fuel electrode and has a power generation function to perform power generation through a reaction between an oxidant gas containing oxygen and the fuel gas supplied from the fuel generator and an electrolysis function to perform electrolysis of a product of the reduction reaction which is supplied from the fuel generator during a renewal period of the fuel generator; the method including: a coating step of coating a surface of the micro-particles in an oxidation state of the fuel generator with a gas-permeable insulating material; and a step of molding a mixture that contains the micro-particles, whose surface is coated with the gas-permeable insulating material, and a material of the fuel electrode, thereafter, burning the mixture, and thereby obtaining the fuel electrode in which the micro-particles of the fuel generator coated with the gas-permeable insulating material are disposed.

Besides, in the production method having the third structure, a structure (fourth structure) may be employed, which includes a reduction step of reducing the micro-particles in the oxidation state of the fuel electrode obtained by the burning, and thereby putting the micro-particles into a reduction state.

Besides, in the production method having the third or fourth structure, a structure (fifth structure) may be employed, which includes a step of, prior to the coating step, forming an organic material layer onto the surface of the micro-particles in the oxidation state of the fuel generator.

Besides, in the production method having the fifth structure, a structure (sixth structure) may be employed, in which the organic material layer is removed by the burning.

Besides, in the system or production method having any one of the first to sixth structures, a structure (seventh structure) may be employed, in which the micro-particles in the oxidation state of the fuel generator are Fe₃O₄ or Fe₂O₃.

Besides, in the system or production method having any one of the first to seventh structures, a structure (eighth structure) may be employed, in which a main body of the fuel generator is iron.

According to the above secondary battery type fuel cell system or the secondary battery type fuel cell system obtained by the above production method, the micro-particles of the fuel generator are disposed in the fuel electrode of the solid oxide type fuel cell portion, namely, disposed near the reaction field (three-phase interface) of the solid oxide type fuel cell portion. Because of this, it is possible to curb the phenomenon, in which the oxide catalyst contained in the fuel electrode material is reduced to agglomerate with the surrounding particles, by the reduction of the micro-particles in the oxidation state of the fuel generator. Accordingly, it is possible to curb the performance deterioration of the fuel electrode and secondary battery type fuel cell system.

### REFERENCE SIGNS LIST

1 fuel generator
2 solid oxide type fuel cell portion
2A solid oxide electrolyte membrane
2B fuel electrode
2C oxidant electrode
3 gas-permeable insulating material
4 container
5 space enclosed by gas-permeable insulating material
6 cover body
7 iron oxide micro-particles
8 particles used as material of fuel electrode 2B, sacrificial material, solvent and the like
9 iron micro-particles

1. A secondary battery type fuel cell system comprising:
micro-particles of a fuel generator that generate a fuel gas through an oxidation reaction and are renewable through a reduction reaction,
a gas-permeable insulating material that covers each of the micro-particles, and
a solid oxide type fuel cell portion that includes a fuel electrode and has
a power generation function to perform power generation through a reaction between an oxidant gas containing oxygen and the fuel gas supplied from the fuel generator and
an electrolysis function to perform electrolysis of a product of the reduction reaction which is supplied from the fuel generator during a renewal period of the fuel generator, wherein
the micro-particles of the fuel generator covered with the gas-permeable insulating material are disposed in the fuel electrode.

2. The secondary battery type fuel cell system according to claim 1, wherein
the micro-particles of the fuel generator are ununiformly distributed in the fuel electrode of the solid oxide type fuel cell portion: the micro-particles of the fuel generator are sparse in a portion near an electrolyte of the solid oxide type fuel cell portion, and the micro-particles of the fuel generator are dense in a portion far from the electrolyte of the solid oxide type fuel cell portion.

3. A method for producing a secondary battery type fuel cell system that includes: micro-particles of a fuel generator that generate a fuel gas through an oxidation reaction and are renewable through a reduction reaction, and
a solid oxide type fuel cell portion that includes a fuel electrode and has a power generation function to perform power generation through a reaction between an oxidant gas containing oxygen and the fuel gas supplied from the fuel generator and an electrolysis function to perform electrolysis of a product of the reduction reaction which is supplied from the fuel generator during a renewal period of the fuel generator, the method comprising:
coating a surface of the micro-particles in an oxidation state of the fuel generator with a gas-permeable insulating material, and
molding a mixture that contains the micro-particles, whose surfaces are coated with the gas-permeable insulating material, and a material of the fuel electrode, thereafter, burning the mixture, and thereby obtaining the fuel electrode in which the micro-particles of the fuel generator coated with the gas-permeable insulating material are disposed.

4. The method for producing a secondary battery type fuel cell system according to claim 3, further comprising reducing the micro-particles in the oxidation state of the fuel electrode obtained by the burning, and thereby putting the micro-particles into a reduction state.

5. The method for producing a secondary battery type fuel cell system according to claim 3, further comprising, prior to the coating, forming an organic material layer onto the surface of the micro-particles in the oxidation state of the fuel generator.

6. The method for producing a secondary battery type fuel cell system according to claim 5, wherein
the organic material layer is removed by the burning.

7. The secondary battery type fuel cell system according to claim 1, wherein
the micro-particles in the oxidation state of the fuel generator are Fe₃O₄ or Fe₂O₃.

8. The secondary battery type fuel cell system according to claim 1, wherein
a main body of the fuel generator is iron.

9. The method for producing a secondary battery type fuel cell system according to claim 3, wherein
the micro-particles in the oxidation state of the fuel generator are Fe₃O₄ or Fe₂O₃.

10. The method for producing a secondary battery type fuel cell system according to claim 3, wherein
a main body of the fuel generator is iron.
